(19) United States
(12) Patent Application Publication
(10) Pub. No.: US 2026/0065358 A1
(43) Pub. Date: Mar. 5, 2026

(54) MULTI-PANE VIEWPORT WITH DYNAMIC MULTI-MODAL CONTENT

(71) Applicant: Walmart Apollo, LLC, Bentonville, AR (US)

(72) Inventors: Seema Chaudhry, Woodside, CA (US); Yen Pham, Danville, CA (US); Helder Silva, Douglas City, CA (US); Karthik Shivkumar, San Jose, CA (US)

(21) Appl. No.: 19/308,680

(22) Filed: Aug. 25, 2025

Related U.S. Application Data
(60) Provisional application No. 63/688,402, filed on Aug. 29, 2024.

(51) Int. Cl. G06Q 30/0601

(52) U.S. Cl. CPC G06Q 30/0643

(57) ABSTRACT

Examples provide personalization for departments, services, and products with an immersive visual shopping experience. Content is automatically curated and personalized in real-time based on user preferences. Categories of items and item details are presented side-by-side within a single multi-pane viewport having a product list pane listing prioritized categories of items in a vertical row and a products detail pane providing details for a selected item. A vertical scroll function enables the user to scroll through the categories in the product list pane, and a horizontal scroll function enables the user to scroll through items for each category without navigating away from the viewport. Video content is shown in a video data pane. Entries for all items in a selected category are shown in an all-items-per-category pane. The multi-pane viewport has a flattened architecture enabling a unified view of categories and products within a single personalized viewport.

### BACKGROUND

Most marketing is currently done through blanket campaigns providing the same or similar information to all users via static presentation methods. Some limited personalization can sometimes be used for marketing based on a customer's past shopping trends and current community trends. However, this can sometimes inadvertently “pigeonhole” a customer into a narrow online experience, which may not actually be useful or desirable to the customer, resulting in annoyance and frustration for the customer, as well lost sales, and unnecessary expense for the retailer.

### BRIEF DESCRIPTION OF THE DRAWINGS

FIG. 1 is an example block diagram illustrating a system providing an immersive visual shopping experience with dynamically personalized content.

FIG. 2 is an example block diagram illustrating an immersive content manager for creating a dynamically personalized immersive visual shopping experience.

FIG. 3 is an example block diagram illustrating a process for personalizing content based on user-specific data.

FIG. 4 is an example diagram illustrating navigation within a multi-pane viewport having a flattened architecture.

FIG. 5 is an example block diagram illustrating a template for a multi-pane viewport showing a product list and product details side-by-side within a single results page.

FIG. 6 is an example block diagram illustrating a template for presenting a product list and product details side-by-side within a multi-pane viewport.

FIG. 7 is an example block diagram illustrating a multi-pane viewport template including a product list pane, a video data pane, a product details pane, and an all-items-per-category pane.

FIG. 8 is an example flow chart illustrating operation of the computing device to populate a multi-pane viewport with personalized content based on user-specific data.

FIG. 9 is an example flow chart illustrating operation of the computing device to populate a product list pane and a product details pane.

FIG. 10 is an example flow chart illustrating operation of the computing device to enable navigation through categories and items via a horizontal scroll function and a vertical scroll function within the product list pane.

FIG. 11 is an example screenshot illustrating a customized multi-pane viewport having personalized content curated for a user.

FIG. 12 is an example screenshot illustrating a customized multi-pane viewport having a product list pane and a product details pane.

FIG. 13 is an example screenshot illustrating options to provide feedback associated with a category of items by providing a thumbs up or a thumbs down indicating the user's interest in the category.

FIG. 14 is an example block diagram illustrating a backend system for dynamically generating personalized content for a user.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

Typically, marketing is done through generic marketing campaigns in which the same information is provided to all customers or large groups of customers in a single format. Currently, some form of limited personalization can be used for marketing based on the customer's past shopping habits and current community trends. These solutions typically do not give users control and “pigeon-holes” them in a narrow online experience, which may not actually be preferred by the user.

Moreover, when viewing categories of items in a homepage or search results page having multiple categories of items with multiple items in each category, it can be a difficult and time consuming task to review information for each of the items, obtain more specific desired information not initially presented with the results, and explore various choices and options available from a retailer or other supplier. Frequently, results are presented within a single product list page having a full page of results in a grid layout with minimal details about each category or item and small imagery to represent the category or item in the results page. Current paradigms have a hub and spoke model where a product listing page take you to a product details page and the user clicks back and forth between pages. Each product details page requires the user to take time to navigate away from the primary results page and upload a new product details page to review more detailed information about the category or item of interest. Contextuality is lost in the process. Moreover, the browser back button is often used to go back to the product listings page multiple times, resulting in unnecessary time wasted loading and reloading the same page over and over again, as well as consuming processor, network, and memory resources as the user navigates from page to page as each server/database call costs time and processing effort for the server. Likewise, each back and forth switching between pages multiplies the calls made to each database/platform that is involved.

For example, if a user is searching for a desk, the search results can include many different categories for desks. Each category of desks can include dozens or hundreds of options. In some cases, a catalog of items can include thousands of categories and sub-categories of items available from one or more retailers and/or suppliers. To obtain additional details about a selected desk, the user is typically diverted to a new product details page which requires the user device to request the page from the webserver and then expend system resources rendering the new page. The user is forced to leave the results page with the various categories of desks to view details about one specific desk. Moreover, if the user wants to compare two different desks, it can require navigating back and forth between the original search results (product list page) and multiple different product details pages. This complicated navigation makes it difficult for customers to explore and discover new categories and items. Moreover, it can be time consuming and frustrating for users due to limitations preventing them from viewing multiple categories and items within the same page for comparisons and broader viewing scope. Thus, in this field of information technology and marketing, there are many limitations and issues preventing or delaying provision of relevant information to users in an efficient manner which is not cost-prohibitive due to vast quantities of information available and the large numbers of recipients receiving the information.

Referring to the figures, examples of the disclosure enable dynamic personalization of multi-modal content within multi-pane viewports for an immersive visual shopping experience. In some examples, a multi-pane viewport is provided which includes a product list pane listing multiple categories of product and a product details pane listing specific details associated with one or more selected items. An item can include physical goods, digital goods, and/or services. Services can include services associated with physical goods, such as product installation services. Services can also include services which are not tied to specific goods, such as streaming video services. The multi-pane viewport enables categories and item details to be displayed side-by-side within a single viewport providing information in multiple different modes, thereby minimizing navigation away from the viewport to other pages. This reduces system resource usage, such as processor, memory and network bandwidth which would otherwise be consumed when a user navigates away from a product list page to a separate product details page and then back to the product list page.

In some embodiments, the system provides an immersive multi-modal visual shopping experience via a multi-pane viewport having a product list pane, a product details pane, a video data pane and a see all-items-per-category pane providing information in text, video, and/or audio modes. The product list pane provides a discovery home screen with categories, sub-categories and/or items associated with each category. The product details pane provides inline details for one or more products side-by-side with the product list pane. Immersive visual shopping data (richer media) is provided via the video data pane. The see all for the category enables the user to view all the items for a given category while still being able to view other categories and inline details for individual items within the other panes without navigating away from the homepage. This provides benefits for usability as it simplifies user browsing and viewing of search results. The flat architecture enables uniformity in shopping patterns that scale for departments while providing familiar patterns that match marketplace experiences.

The computing device operates in an unconventional manner by providing item and category information in multiple panes within a single viewport with a flattened architecture to reduce user navigation to different webpages as well as increase user convenience. In this manner, the computing device is used in an unconventional way and allows reduced system resource usage which would otherwise be consumed during loading of different item and category specific webpages, thereby improving the functioning of the underlying computing device.

In other examples, the system enables provision of items and category data in side-by-side visual panes within a single homepage customized for a user within a user interface (UI). This enables increased user efficiency via the UI interaction and increased user interaction performance. The system allows for an indulgent shopping space where a user can browse and find rich imagery that leads them to easy browsing and easy shopping. It is a mode of shopping that is discovery based rather than merely search based.

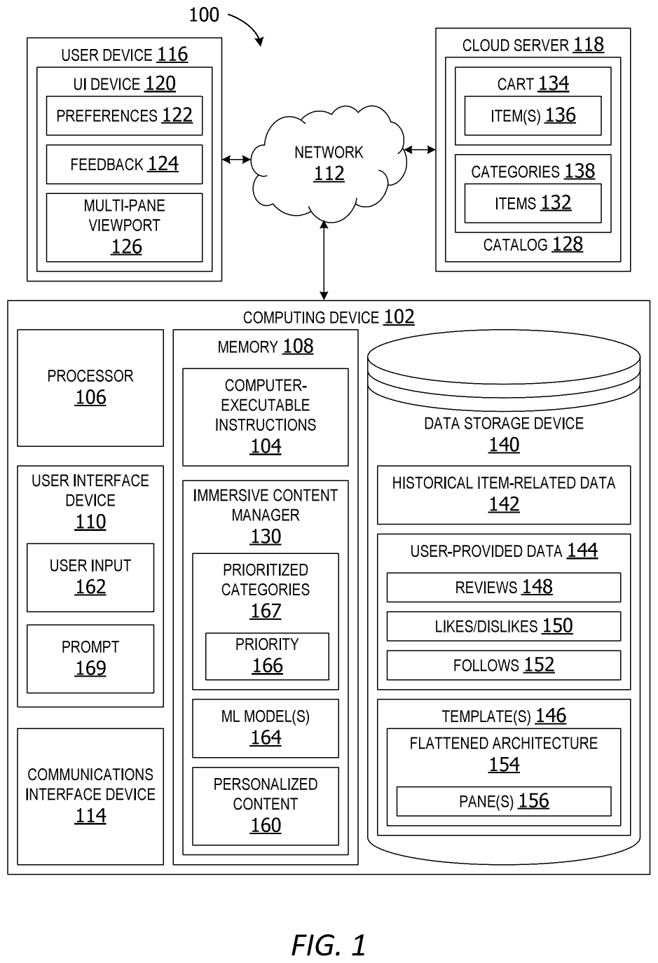

Referring again to FIG. 1, an example block diagram illustrates a system 100 for providing an immersive visual shopping experience with dynamically personalized content. In the example of FIG. 1, the computing device 102 represents any device executing computer-executable instructions 104 (e.g., as application programs, operating system functionality, or both) to implement the operations and functionality associated with the computing device 102. The computing device 102, in some examples includes a mobile computing device or any other portable device. A mobile computing device includes, for example but without limitation, a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

In some examples, the computing device 102 has at least one processor 106 and a memory 108. The computing device 102, in other examples includes a user interface device 110.

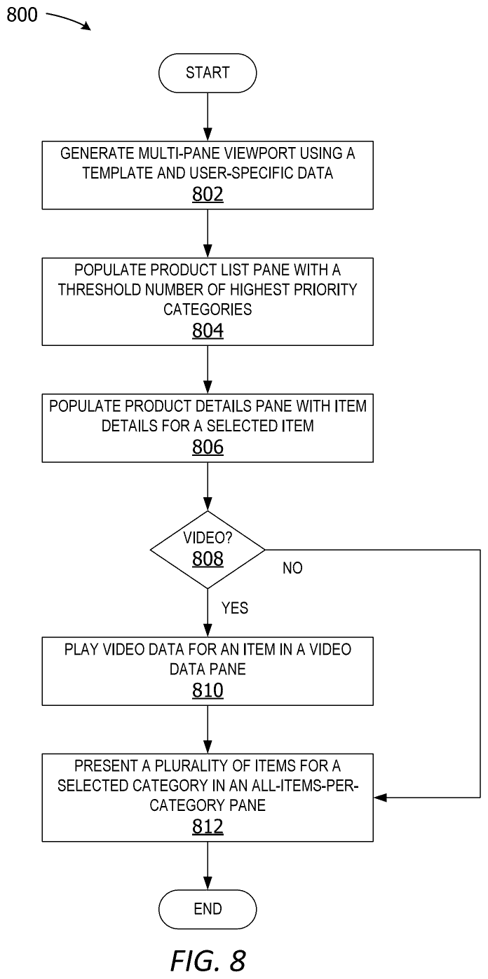

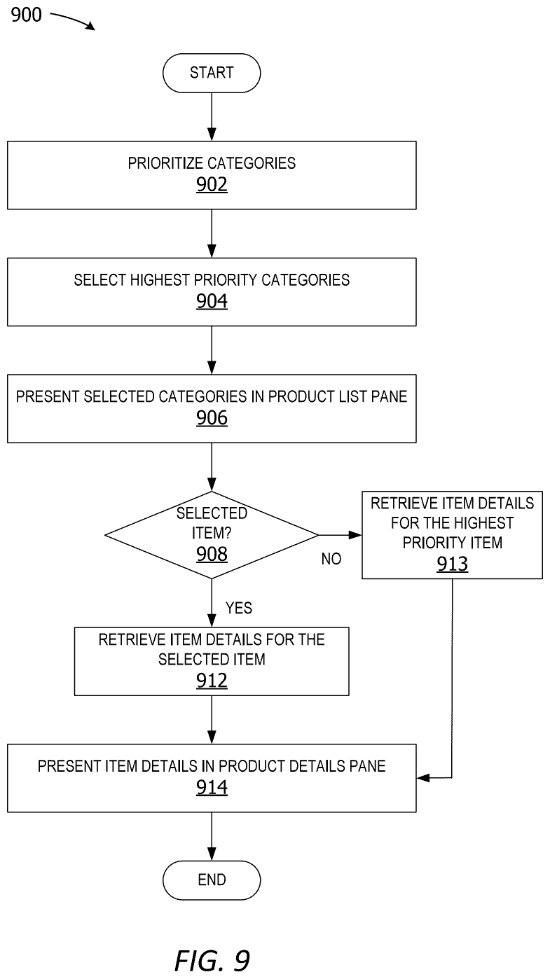

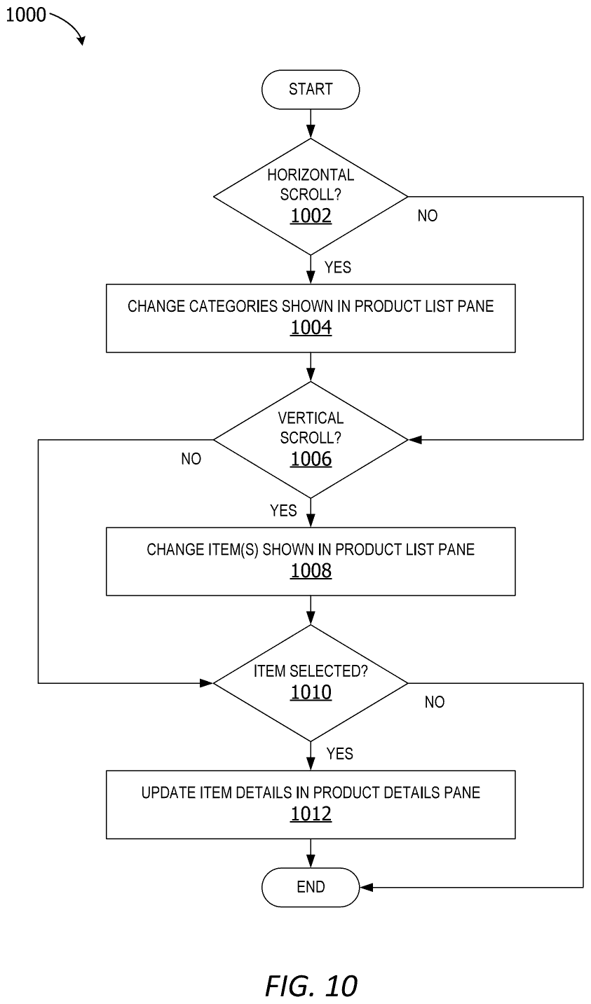

The processor 106 includes any quantity of processing units and is programmed to execute the computer-executable instructions 104. The computer-executable instructions 104 are performed by the processor 106, performed by multiple processors within the computing device 102 or performed by a processor external to the computing device 102. In some examples, the processor 106 is programmed to execute instructions such as those illustrated in the figures (e.g., FIG. 8, FIG. 9, and FIG. 10).

The computing device 102 further has one or more computer-readable media such as the memory 108. The memory 108 includes any quantity of media associated with or accessible by the computing device 102. The memory 108 in these examples is internal to the computing device 102 (as shown in FIG. 1). In other examples, the memory 108 is external to the computing device (not shown) or both (not shown). The memory 108 can include read-only memory and/or memory wired into an analog computing device.

The memory 108 stores data, such as one or more applications. The applications, when executed by the processor 106, operate to perform functionality on the computing device 102. The applications can communicate with counterpart applications or services such as web services accessible via a network 112. In an example, the applications represent downloaded client-side applications that correspond to server-side services executing in a cloud.

In other examples, the user interface device 110 includes a graphics card for displaying data to the user and receiving data from the user. The user interface device 110 can also include computer-executable instructions (e.g., a driver) for operating the graphics card. Further, the user interface device 110 can include a display (e.g., a touch screen display or natural user interface) and/or computer-executable instructions (e.g., a driver) for operating the display. The user interface device 110 can also include one or more of the following to provide data to the user or receive data from the user: speakers, a sound card, a camera, a microphone, a vibration motor, one or more accelerometers, a BLUETOOTH® brand communication module, wireless broadband communication (LTE) module, global positioning system (GPS) hardware, and a photoreceptive light sensor. In a non-limiting example, the user inputs commands or manipulates data by moving the computing device 102 in one or more ways.

The network 112 is implemented by one or more physical network components, such as, but without limitation, routers, switches, network interface cards (NICs), and other network devices. The network 112 is any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other examples, the network 112 is a local or private LAN.

In some examples, the system 100 optionally includes a communications interface device 114. The communications interface device 114 includes a network interface card and/or computer-executable instructions (e.g., a driver) for operating the network interface card. Communication between the computing device 102 and other devices, such as but not limited to a user device 116 and/or a cloud server 118, can occur using any protocol or mechanism over any wired or wireless connection. In some examples, the communications interface device 114 is operable with short range communication technologies such as by using near-field communication (NFC) tags.

The user device 116 represents any device executing computer-executable instructions. The user device 116 can be implemented as a mobile computing device, such as, but not limited to, a wearable computing device, a mobile telephone, laptop, tablet, computing pad, netbook, gaming device, and/or any other portable device. The user device 116 includes at least one processor and a memory. The user device 116 can also include a user interface device (UI) device 120.

The UI device 120 is a device for receiving data from a user or displaying data to the user, such as, but not limited to, the user interface device 110. In this example, the user provides data associated with the user's preferences 122 and/or feedback 124 to an immersive contents manager 130. The user views personalized content created by the immersive content manager 130 via the UI device 120, such as, but not limited to, a multi-pane viewport 126.

The multi-pane viewport 126 is a webpage or homepage accessed by a user via a website or an application on the user device 116. The multi-pane viewport 126 includes two or more panes within a single page. Each pane displays different types of information. For example, a product list pane displays one or more categories of items side-by-side with a product details pane presenting detailed information about a single item. In this manner, a user does not have to navigate away from a primary page displaying product categories in order to view more specific details for a category or item. This reduces system resource usage consumed by user navigation from one page to another page as the user can view all information within the various panes of the multi-pane viewport.

The cloud server 118 is a logical server providing services to the computing device 102 or other clients, such as, but not limited to, the user device 120. The cloud server 118 is hosted and/or delivered via the network 112. In some non-limiting examples, the cloud server 118 is associated with one or more physical servers in one or more data centers. In other examples, the cloud server 118 is associated with a distributed network of servers.

In some examples, the cloud server 118 provides information to the immersive content manager 130 on the computing device 120 and/or the user device 116. In this example, the cloud server includes a catalog 128 including a plurality of items 132 within a plurality of categories 138. A category is a group of items having one or more features in common. For example, a catalog of food items can include categories of different types of food, such as a produce category, meat category, bakery category, frozen foods category, pet food category, etc. Each category includes multiple items. For example, the bakery category can include bread, rolls, cookies, cakes, muffins, etc.

In other examples, the cloud server 118 maintains a customer cart 134 containing one or more item(s) 136 selected by a user for purchase from the catalog 128 of items available for purchase. The cart 134 can be referred to as a basket. However, the examples are not limited to the catalog 128 and cart 134 being maintained on the cloud server 118. In other embodiments, the cart 134 and/or the catalog 128 are maintained on the computing device 102 and/or some other remote database or storage device. In still other examples, the cart 134 can be maintained on an application associated with the user device 116.

The system 100 can optionally include a data storage device 140 for storing data, such as, but not limited to historical item-related data 142, user-provided data 144, and/or template(s) 146. Historical item-related data 142 is historical data associated with a specific user, including historical transaction data associated with items purchased, ordered, viewed online, clicked online, etc. The historical item-related data 142 includes previous items purchased/ordered, items viewed, and other purchase-related behavior. User-provided data 144 is any user-specific data provided directly or indirectly by the user. The user-provided data 144 is used to determine user preferences and interests. The user-provided data 144 can include any type of user-related information, such as, but not limited to, item reviews 148, likes/dislikes 150 associated with items, and/or follows 152. An item can include physical goods, digital goods, and/or services.

The one or more template(s) 146 includes templates for a multi-pane viewport having a flattened architecture 154 with two or more information pane(s) 156 enabling the user to view/obtain information associated with different types of items and/or different types of categories of items simultaneously within a single viewport. As used herein, a viewport refers to a webpage or window.

The data storage device 140 can include one or more different types of data storage devices, such as, for example, one or more rotating disks drives, one or more solid state drives (SSDs), and/or any other type of data storage device. The data storage device 140 in some non-limiting examples includes a redundant array of independent disks (RAID) array. In some non-limiting examples, the data storage device(s) provide a shared data store accessible by two or more hosts in a cluster. For example, the data storage device may include a hard disk, a redundant array of independent disks (RAID), a flash memory drive, a storage area network (SAN), or other data storage device. In other examples, the data storage device 140 includes a database.

The data storage device 140 in this example is included within the computing device 102, attached to the computing device, plugged into the computing device, or otherwise associated with the computing device 102. In other examples, the data storage device 140 includes a remote data storage accessed by the computing device via the network 112, such as a remote data storage device, a data storage in a remote data center, or a cloud storage.

The memory 108 in some examples stores one or more computer-executable components, such as, but not limited to, the immersive content manager 130. The immersive content manager component, when executed by the processor 106 of the computing device 102, generates personalized content 160 using user-provided data 144 and other user input 162 indicating user preferences 122 and interests. The personalized content 160 includes a list of prioritized categories and items predicted to be of interest to the user by one or more machine learning (ML) model(s) 164. The one or more ML model(s) 164 include pre-trained ML models for predicting categories and items likely to be of interest to the user based on user preferences 122, feedback 124, historical item-related data 142, and other user-provided data 144. The ML model ranks the categories and/or items based on how likely a category or item is likely to be of interest to the user. The highest ranked (prioritized) categories and/or items are presented to the user via the UI device 120.

In some embodiments, the immersive content manager 130 calculates a priority 166 for each category based on predicted interests of the user, promotions, sponsored categories/sponsored items, etc. In other words, the categories are prioritized using user-specific data, including historical item-related data 142 for a user. Each category of items in the prioritized categories 167 is assigned a rank or score indicating the priority of each category relative to the other categories. The prioritization of the categories is different for each user because the categories are ranked in accordance with the user's preferences, interests, historical transactions/previous purchases, etc.

The immersive content manager 130 selects a threshold number of highest priority categories from the prioritized categories 167. The immersive content manager 130 presents the highest priority categories within a product list pane within the multi-pane viewport 126. A vertical scroll function enables navigation through categories displayed within the product list pane. A horizontal scroll function enables navigation through items of each category presented in the product list pane. The immersive content manager 130 replaces a first category presented in the product list pane with a second category in response to a vertical scroll within the product list pane. The vertical scroll enables the user to view additional categories within the product list pane.

In other embodiments, the immersive content manager 130 replaced a first item associated with a selected category in the product list pane with a second item associated with the selected category in response to a horizontal scroll. The horizontal scroll enables the user to view each item associated with each category within the product list pane. The immersive content manager 130 populates a product details pane of the multi-pane viewport with item detail data associated with a selected item from a selected category. The immersive content manager 130 changes the item details data within the product details pane of the multi-pane viewport if a user selection of a second item in the product list pane is detected. The changed item details data includes data describing the second item. The multi-pane viewport 126 provides a flattened architecture enabling a unified view of item categories and item details within a single personalized viewport.

In other embodiments, the multi-pane viewport 126 includes a display video data pane that displays video data associated with a currently selected item. The video data can include still (static) images as well as video with moving images and/or audio.

In other embodiments, the multi-pane viewport 126 includes a see all-items-per-category pane that displays multiple entries representing multiple items within a selected category of the categories 138. Each entry representing an item can include an image of the item, a name of the item, and/or other information associated with the item.

The system 100 analyzes the manner in which different users are interacting with different data to then present it at different levels on a per-user personalization basis. The system, in some embodiments, uses one or more ML model(s) 164 to curate and customize a view for a given user, presenting a personalized view of a home page, search results page, application landing page, or other viewport for an e-commerce site/application that displays information for categories, departments, goods and/or services the given user is interested in. The system 100 uses dynamic user input 162, including current inventory, locale (geography) of the user's location (residence), historical item-related data 142 (purchase history), user behavior, user data interaction, seasonality, and other relevant information to curate the customer view/shopping experience for the individual user. When the user logs into the e-commerce website or application, the personalized experience/view is tied to a user profile or other membership information and/or linked to an instance of the application executing on the user device.

In other embodiments, the system 100 implements a feedback loop based on the user interaction with data and purchases made via the application/website to refine the ML model(s) 164 for better curation for the user. The system dynamically modifies the curated selection using infinite vertical and/or horizontal scroll, as well as user feedback 124 based on the user interaction with data in real time. The system 100 takes user specified likes, interests, and other feedback (e.g., like, heart, save, star, share, follow, unfollow, more of this, less of this, improve my feed setting, etc.) to refine the curation and to generate targeted promotions during the online shopping experience.

In some embodiments, the immersive content manager 130 generates a prompt 169 encouraging the user to provide feedback regarding an item or category. For example, the prompt 169 can include a request for the user to rate a product the user has purchased, select a thumbs up icon indicating the user likes the item, select a thumbs down icon indicating the user dislikes the item, select a heart or star icon indicating a preference for the item, select an option to share information about the item with someone else via a social media post or message, etc. In these examples, the prompt is presented to the user via a UI, such as, but not limited to, the user interface device 110 and/or the UI device 120 in FIG. 1. However, the embodiments are not limited to prompting a user to provide feedback 124. In other embodiments, the user has the option to provide various forms of feedback by clicking on an icon associated with an item or category entry displayed within one or more panes of the multi-pane viewport 126.

In the above example shown in FIG. 1, the personalized content 160 is presented to the user via the multi-pane viewport 126. However, the examples are not limited to a multi-pane viewport. In other examples, the personalized content 160 can be presented to the user via a single pane viewport (traditional homepage or search results page). In such cases, the user navigates from the traditional product list page to a product details page or other page to view additional details associated with a selected category or a selected item. This results in reducing human labor and time spent on manual curation of content, which is no longer required. Advertisements and promotions are optimized as content is personalized to those having the greatest interest in the promotional items and discounts. Local/geographic and seasonal factors are considered to further customize and personalize recommendations and search results for each user, thereby maximizing local relevance to catalog items and further improving customer satisfaction and efficiency while utilizing the UI.

In other embodiments, the immersive content manager 130 enables the user to personalize departments, services, and/or products recommendations. The method allows a user to select the store departments, sub-categories, and/or services they are interested in at a given point in time via a UI, such as, but not limited to, the user interface device 110 and/or the UI device 120. The user is allowed to update preferences of store departments, sub-categories and/or services periodically based on what they want via the user input 162. The method gives the user full control on what data is used to show highlights of departments and services (instead of completely AI based solution that pigeon-holes recommendations).

In some embodiments, the preferences control is implemented as a module within the user's shopping/interaction experience via a UI associated with the e-commerce website/application. The user experience is related to product information, promotional materials, personalized suggestions, and/or general categories. The UI comprises a function that allows the user to view and set user personalized preferences 122, such as via feedback 124. In this manner, the system automatically creates personalized content for users based upon their browsing and purchase histories. In some examples, the one or more ML model(s) 164 select the appropriate product categories to display to each user as automated generation of the site content. The system 100 displays items (products and services) by category and sub-category and also displays product videos within the multi-pane viewport 126.

In one example, the system prompts the user to select the departments, sub-categories, services they might be interested in, such as via the prompt 169. The user can change these preferences 122 dynamically in real-time to trigger updating of the prioritized categories 167 and/or items presented to the user via the multi-pane viewport 126. This gives the user full control over what data is selected for presentation to the user and/or customization of the multi-pane viewport 126 to show highlights of departments and services predicted to be of greatest interest to the user. Instead of a completely AI based solution, this feature enables the user to have full or partial control on what criteria is applied by the ML model(s) 164 when customizing content for the user. The ML model(s) 164 learns from purchase behavior obtained from historical item-related data 142 and/or from user feedback 124. This process of allowing the individual to set preferences enables the system to more accurately and reliably generate individual personalized suggestions based on predictions for the user. Thus, when the system identifies the best matches of categories and items for the user, the individual can further fine tune their preferences. This enables the system to further optimize more suitable matches of categories and items. This personalization and user preference control can apply to advertising or personalized suggestions, even general categories of items.

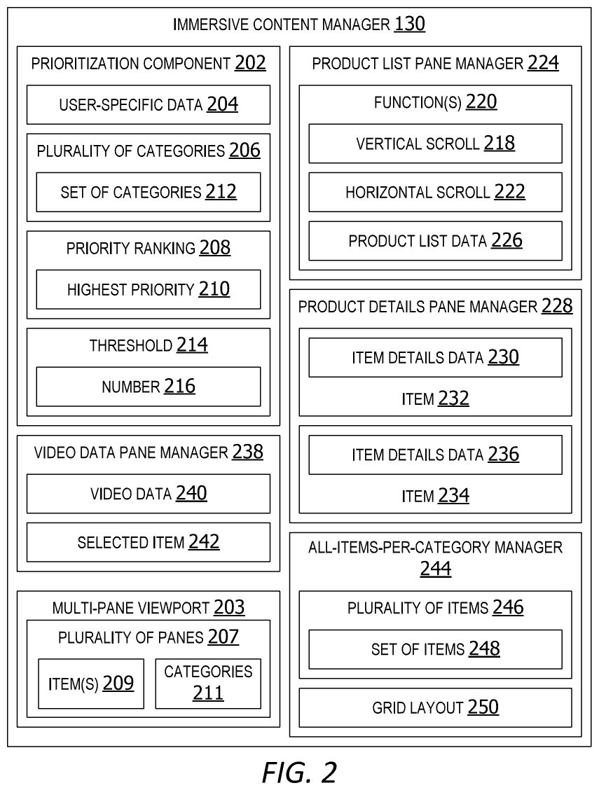

FIG. 2 is an example block diagram illustrating an immersive content manager 130 for creating a dynamically personalized immersive visual shopping experience. The immersive content manager 130 uses user-specific data 204 to dynamically generate a unified, multi-pane viewport 203 comprising a plurality of panes 207 displaying personalized content associated with one or more item(s) 209 and prioritized categories 211 of items. The prioritized categories 211 of items include a sub-set of the plurality of categories initially displayed within one or more panes in the plurality of panes 207 within the multi-pane viewport 203. The user can view additional prioritized categories by engaging a scroll function, such as, but not limited to, a vertical scroll 218 and/or a horizontal scroll 222. As the user scrolls through the categories, the categories are displayed in descending order of highest priority (most likely to be of interest) to lower priority (less likely to be of interest) to the user based on the user-specific data available to the immersive content manager 130. The multi-pane viewport 203 is a viewport having two or more panes for displaying items and/or category related data, such as, but not limited to, the multi-pane viewport 126 in FIG. 1.

In some embodiments, a prioritization component 202 analyzes a plurality of categories 206 of items within a catalog of items with user-specific data 204 to generate a priority ranking 208 for each category. The priority ranking 208 is any type of score or ranking indicating a predicted level of interest of a user for each category in the plurality of categories. The plurality of categories 206 includes categories of items, such as, but not limited to, the categories 138 in FIG. 1.

The priority ranking 208 in some embodiments is generated by an ML model, such as the one or more ML models 164 in FIG. 1. In other words, the prioritization component 202 optionally includes one or more trained ML models for prioritizing the plurality of categories 206. The priority ranking 208 can include a score or ranking from one to ten, a percentage score, a grade, or any other type of ranking or scoring for indicating a degree of priority for each category.

The prioritization component 202 selects a threshold 214 number 216 of the highest priority 210 categories from the plurality of categories 206. The selected threshold 214 number 216 of highest priority 210 categories is a set of categories 212 included within the product list pane of the multi-pane viewport. The set of categories 212 is a set of one or more highest priority categories 212 initially presented within the product list pane. However, the user can use one or more function(s) 220, such as a vertical scroll 218 and/or a horizontal scroll 222, to change the categories and/or items which are displayed in the product list pane. In this manner, the user can view all the categories and/or items for each category using the scroll function(s) 220.

A product list pane manager 224 populates a product list pane of the multi-pane viewport with product list data 226, including the threshold 214 number 216 of categories from the plurality of categories 206. In some embodiments, an entry for each category shown in the product list pane includes an image associated with the category and/or a word or title for each category. The image can include a thumbnail type image of an item representing the category. For example, a category for flowers can include an image of a rose with the title “flowers” or “floral” for the category in the product list pane.

In other embodiments, a product details pane manager 228 populates a product details pane with item details data 230 associated with a first selected item 232. The first selected item is a highest priority item predicted to be of greatest interest to the user. In some cases, the first selected item is an item that is responsive to a search request by the user. In other examples, the first selected item is a promotional item, or a sponsored item predicted to be of interest to the user by a ML model, such as, but not limited to, the one or more ML model(s) 164 in FIG. 1. If the user selects an item from one or more of the categories presented in the product list pane, the product details pane manager 228 replaces the item details data 230 for the initial item 232 with the item details data 236 for the newly selected item 234. In this manner, the user can view details for a category or item without navigating away from the multi-pane viewport page. This reduces network bandwidth usage as well as memory and processor usage which would be consumed in requesting a separate product details webpage and rendering the product details webpage.

An all-items-per-category manager 244 in some embodiments generates a grid layout 250 for displaying a set of items 248 within a plurality of items 246 for a selected category of items in the plurality of categories 206. The user can perform a vertical scroll to load additional entries of additional items in the selected category. In other words, if the user wishes to view items for the category which are not visible within the all-items-per-category pane, a vertical scroll triggers replacement of the currently visible set of items with the additional items enabling the user to view all the items in the category within one pane while still being able to refer to the categories of items in the product list pane and/or specific item details in the product details pane.

Other embodiments includes a video data pane manager 238. The video data pane manager 238 displays video data 240 for a selected item 242 within a video data pane. The video data 240 can include moving images (video content) with audio and/or still images without audio. The video data pane manager 238 enables the user to view immersive visual information associated with one or more items within the multi-pane viewport while also being able to reference the categories displayed in the product list pane, the specific item details in the product details pane, and/or all the items in a given category shown in the all-items-per-category pane. In this manner, the immersive content manager creates a customized multi-pane viewport having a flattened architecture enabling a unified view of item categories and item details within a single personalized viewport for an immersive visual shopping experience.

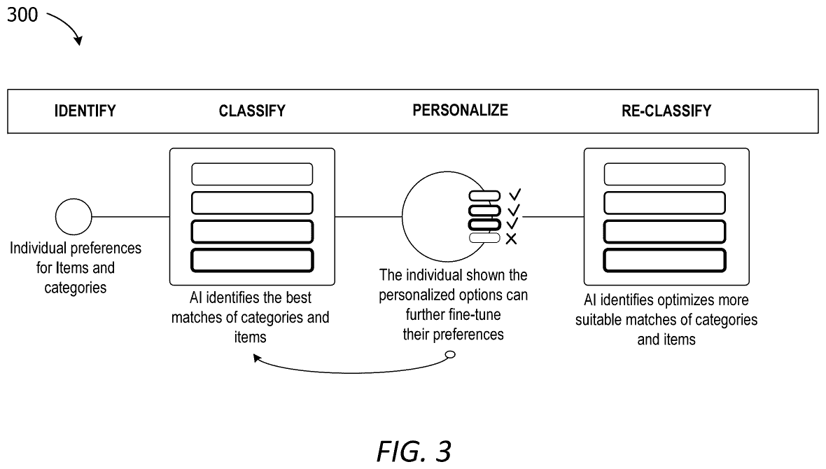

Turning now to FIG. 3, an exemplary block diagram illustrating a process 300 for personalizing content based on user-specific data is shown. In some embodiments, the immersive content manager 130 obtains user-specific data associated with individual preferences for items and categories of items. The artificial intelligence (AI)/ML model identifies the best matches of categories and items. The AI/ML model is a trained ML model for predicting items and categories likely to be of interest to the user, such as, but not limited to, the one or more ML model(s) 164 in FIG. 1. The immersive content manager prioritizes the categories and/or items. The highest ranked/prioritized categories and/or items are the best matches. The categories and/or items are presented to the user via a homepage, search results page, recommended items page, or other viewport, such as, but not limited to, the multi-pane viewport 126 in FIG. 1 and/or the multi-pane viewport 203 in FIG. 2.

The user can further fine-tune their preferences by providing feedback indicating which items and/or categories are of interest to the user and which are not of interest. In some examples, the user can select an option to request “more like this” or “less like this.” In other examples, the user can select an icon indicating the user likes a category or individual item, such as a thumbs up icon, heart icon, star icon, etc. Likewise, the user can indicate an item, or category is undesirable to the user by selecting an icon, such as a thumbs down icon, a letter x icon, etc.

The immersive content manager AI/ML model re-prioritizes the categories and/or items based on the updated user feedback and preferences. The immersive content manager identifies and optimizes more suitable matches of categories and items based on the updated priority rankings/scores for each category/item. In this manner, the system provides a feedback loop in which the categories and items which are recommended to the user and/or presented to the user in response to a search, promotion, or product recommendation is increasingly tailored and customized to the user's needs and preferences.

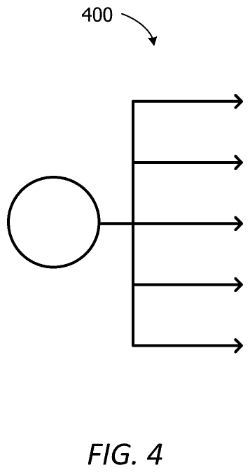

FIG. 4 is an example diagram illustrating navigation within a multi-pane viewport having a flattened architecture 400. As shown here, a user can engage with an item or category presented within the product list pane of the multi-pane viewport to obtain additional information regarding the category and/or item, view video data associated with the category and/or item, or otherwise view additional categories and/or items without navigating away from the multi-pane viewport. The calls need to be made once to the involved systems to render the multi-pane viewport, which is exponentially more efficient.

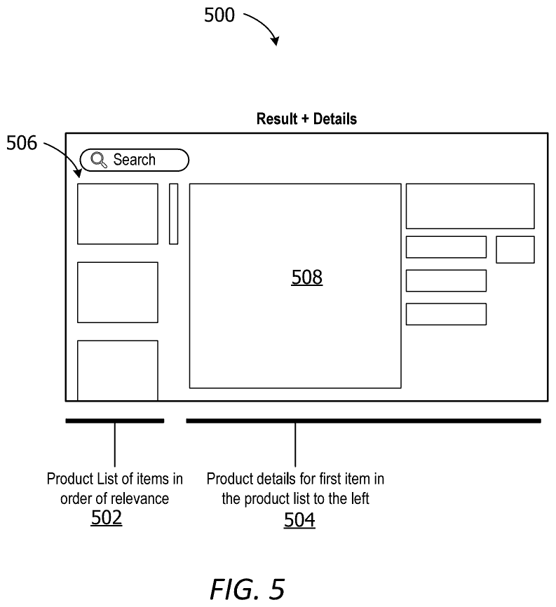

FIG. 5 is an example block diagram illustrating a template 500 for a multi-pane viewport showing a product list 502 and product details 504 side-by-side within a single results page. In this example, the product list 502 includes a horizontal row of categories within the product list pane 506. The product list pane 506 layout allows space for three category entries presented in order of priority with a highest priority category listed first (at the top of the horizontal row). However, the embodiments are not limited to a multi-pane viewport having three category entries within the product list pane 506. In other embodiments, the product list pane can include a single category entry, two category entries, as well as four or more category entries.

The product details for a selected item (first item) in the product list to the left are presented within a product details pane 508 that can be viewed simultaneously with the categories displayed within the product list pane 506. Initially, the product details 504 for the first item in the first category listed in the product list pane are presented. However, afterwards, a user can select a different item. The product details pane is updated to show details for the selected item rather than the first item for the first category in the product list pane. In some examples, the items for each category are also prioritized such that the first item for the first category is a highest priority item in the highest priority category. In this manner, item details are initially presented for the item predicted to be of greatest interest to the user until the user selects a different item.

The video data pane 704 enables the system to keep rich media at the forefront with video, audio, and/or imagery that shows the versatile use of the selected item being shown. A user can easily add an item to the user's cart by clicking/tapping the “add” icon. The user can provide feedback regarding the item shown by clicking the “like” or “share” icons. The user can view additional details for the item without navigating away from the homepage by clicking the “details” icon.

In some examples, when the user taps an item, the system goes into a “super indulgent mode” with a full bleed video for the item with a story describing the item and/or uses of the item. The user can add the item, like the item, share it, and see further details before choosing to swipe horizontally to view a different item and/or add the item to the user's cart. Clicking or selecting the “more information” icon triggers display of additional product/item details 710 within a bottom portion of the video data pane, wherein the details 710 are presented over the video/media being displayed within the video data pane 704.

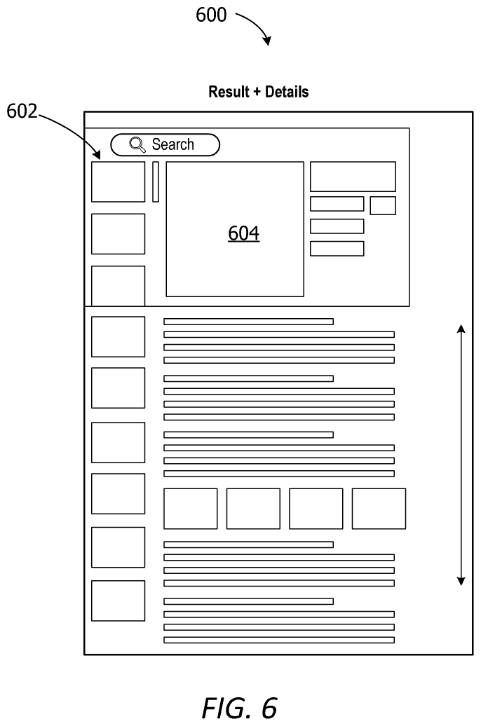

FIG. 6 is an example block diagram illustrating a template 600 for presenting a product list 602 and product details 604 side-by-side within a multi-pane viewport. The user can perform a vertical scroll to view additional categories and/or additional details associated with a selected item.

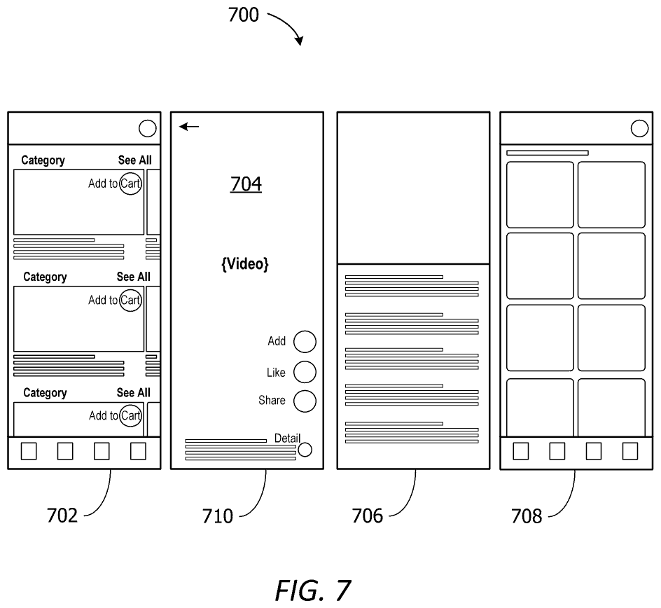

Referring now to FIG. 7, an example block diagram illustrating a multi-pane viewport template 700 including a product list pane 702, a video data pane 704, a product details pane 706 and an all-items-per-category pane 708 is shown. In this example, the product list pane 702 is shown to the far left in the multi-pane viewport template 700, the all-items-per-category pane 708 is shown to the right, the video data pane 704 is between the product list pane and the product details pane 706. However, the embodiments are not limited to the layout shown in FIG. 7. In other examples, the product list pane can be shown in the middle or to the right. Likewise, the product details pane 706 can be adjacent to the product list pane 702, beneath the product list pane 702, or to the right side of the all-items-per-category pane 708. In other words, the various panes may be arranged in any manner or location within the multi-pane viewport.

FIG. 8 is an example flow chart illustrating operation of the computing device to populate a multi-pane viewport with personalized content based on user-specific data. The process 800 shown in FIG. 8 is performed by an immersive content manager component, executing on a computing device, such as the computing device 102 or the user device 116 in FIG. 1.

The process begins by generating a multi-pane viewport using a template and user-specific data at 802. The multi-pane viewport is a homepage, search results page, product recommendation page, application landing page, or other multi-pane window for viewing item and/or category information within multiple panes simultaneously, such as, but not limited to, the multi-pane viewport 126 in FIG. 1 and/or the multi-pane viewport 203 in FIG. 2. The product list pane is populated with a threshold number of highest priority categories at 804. The product details pane is populated with item details for a selected item at 806. If no item is selected, the selected item is the first item associated with the first category in the product list pane. A determination is made whether video data for the selected item is available at 808. If yes, the video data for the item is played within a video data pane at 810. In some examples, the video data is played automatically. In other examples, the video data is only played if activated by the user. The user activates the video by clicking or tapping a play icon or other video control icon. A plurality of items for a selected category is presented within an all-items-per-category pane at 812. The selected category is the first category (highest priority) category in the products list pane, or a category selected by the user from the products list pane. The user selects an item or category by clicking on the entry for the item or category displayed within one or more panes in the multi-pane viewport. The process terminates thereafter.

While the operations illustrated in FIG. 8 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 8.

FIG. 9 is an example flow chart illustrating operation of the computing device to populate a product list pane and a product details pane. The process 900 shown in FIG. 9 is performed by an immersive content manager component, executing on a computing device, such as the computing device 102 or the user device 116 in FIG. 1.

The process begins by prioritizing the categories at 902. The categories are prioritized based on user-specific data indicating user preferences, such as likes, dislikes, etc. The highest priority categories are selected at 904. In some examples, a threshold number of categories are selected. The selected categories are presented in a product list pane at 906. A determination is made whether an item is selected from the product list pane at 908. An item is selected when the user clicks or taps on the item entry. If yes, the item details for the item are retrieved at 912. If an item is not selected, item details are retrieved for the highest priority item at 913. The item details for the selected item or highest priority item are presented in the product details pane at 914. The process terminates thereafter.

While the operations illustrated in FIG. 9 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 9.

FIG. 10 is an example flow chart illustrating operation of the computing device to enable navigation through categories and items via a horizontal scroll function and a vertical scroll function within the product list pane. The process 1000 shown in FIG. 10 is performed by an immersive content manager component, executing on a computing device, such as the computing device 102 or the user device 116 in FIG. 1.

The process begins by determining if a horizontal scroll is activated at 1002. If yes, the categories shown in the product list pane are changed 1004. If the horizontal scroll is not activated at 1002 or after the product list pane is changed (updated) at 1004, a determination is made whether a vertical scroll is activated at 1006. If yes, the item(s) shown in the product list pane are changed at 1008. If the vertical scroll is not activated or after the item(s) are changed in response to the vertical scroll at 1008, a determination is made whether an item is selected at 1010. If yes, the item details in the product details pane is updated at 1012. The product details pane is updated with item details for the selected item. If an item is not selected at 1010 or after the product details pane is updated at 1012, the process terminates thereafter.

While the operations illustrated in FIG. 10 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 10.

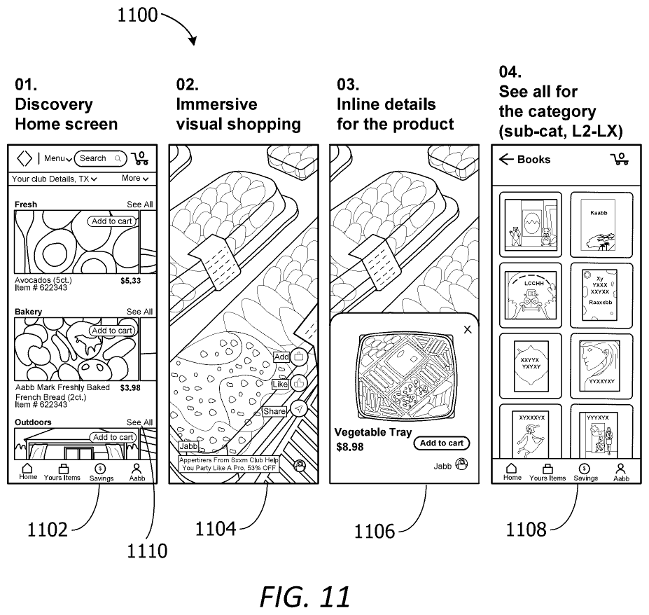

FIG. 11 is an example screenshot illustrating a customized multi-pane viewport 1100 having personalized content curated for a user. In this example, the multi-pane viewport 1100 includes a products list pane 1102, a video data pane 1104, a product details pane 1106, and a see all-items-per-category pane 1108. In this example, the multi-pane viewport 1100 is populated with food category entries, an outdoors category entry, food item details, video associated with a selected food item, and books. However, the embodiments are not limited to the items and categories shown in FIG. 11. In other embodiments, the multi-pane viewport can be populated with entries for any types of items and/or categories not currently shown in FIG. 11.

The multi-pane viewport enables a user to see “x” levels of data for each category. A user can swipe horizontally to view additional items in the row of items for each category. Any item of interest can be added to the user's cart (basket) with a single tap/click on an “add to cart” icon presented within the product details pane 1106. Personalized ads and sponsored items are embedded within the multi-pane viewport based on the category, sub-category, service, or department in question. Scrolling down exposes more categories, sub-categories and departments or services.

In some embodiments, the user can select a “see all” icon 1110 in the product list pane 1102. Once selected, the user can see a grid of all the items for that category displayed on a vertical scroll within the see all-items-per-category pane 1108 without leaving the multi-pane viewport homepage.

In some examples, the multi-pane viewport model has a flattened architecture permitting multiple different panes of information to be displayed side-by-side rather than using a hub and spoke model which results in frequent loading and reloading of pages as the user navigates from product list pages to product details pages. Results (product list pane) and details (product detail pane) are viewable in the same viewport (window)/layout. This allows visual comparison between products, quick selection for detailed comparison, if necessary. Details to any item in the list can be accessed with a click on the same page, without losing context. An unlimited number of results can be shown on the product list pane, where the toggle to see details is available to provide additional details for any selected item. Search is also available on the same framework/layout to allow for a brand new search or an altered term in the search. This allows for full control on the users' side. This mode of inclusive shopping makes the item/product accessible and approachable much more easily. From a technical perspective, the listing page (product listing pane) is called (rendered) once and lazy load is deployed for results in the product list pane. This provides savings on the number of calls made to render the listing page each time a user browses back to the listing page.

The items and categories are listed within the product list pane and/or the see all-items-per-category pane in order of relevance. The product details for the first item in the product list is shown within the product details pane to the left of the product list pane, in this example. The product details are easily accessible. The full product details list is scrollable. No information is lost or reduced by using this layout with regard to product details. Add to cart or other actions are possible on both the listing side and details side.

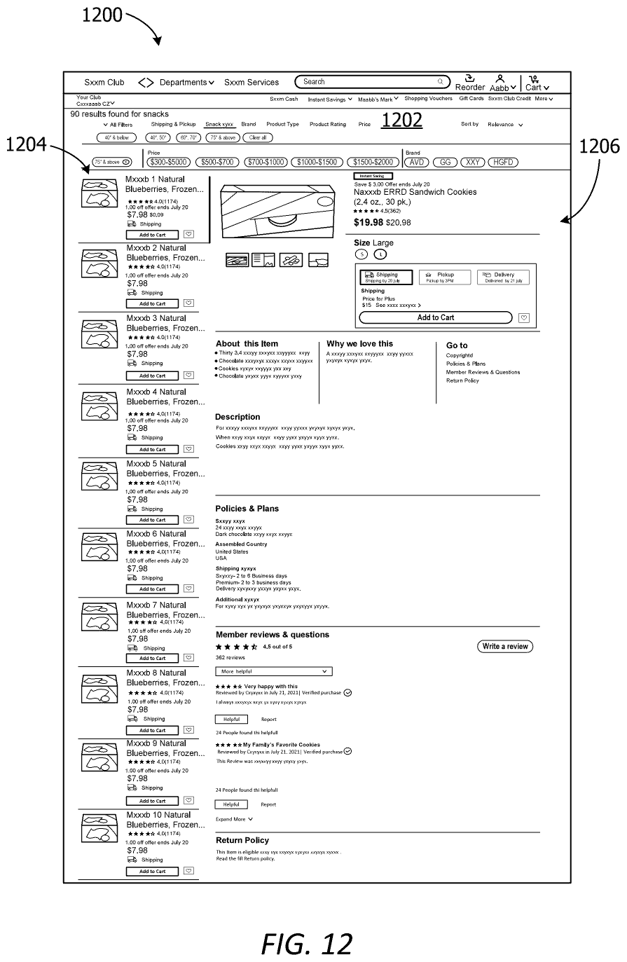

FIG. 12 is an example screenshot 1200 illustrating a customized multi-pane viewport 1202 having a product list pane 1204 and a product details pane 1206. In this example, the product list pane 1204 is adjacent to the product details pane 1206. This multi-pane viewport does not include a video data pane or a see all-items-per-category pane. However, the embodiments are not limited to a products details pane that is side-by-side with the products list pane. In other embodiments, the multi-pane viewport includes a video data pane with the product list pane and the product details pane. In still other examples, the multi-pane viewport 1202 includes a see all-items-per-category pane with the products list pane 1204 and the product details pane 1206.

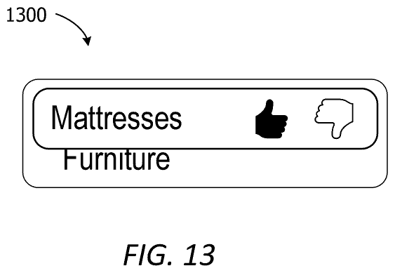

FIG. 13 is an example screenshot 1300 illustrating options to provide feedback associated with a category of items by providing a thumbs up or a thumbs down indicating the user's interest in the category. In this example, the feedback is being provided for a sub-category of mattresses with a primary category of furniture. However, the examples are not limited to obtaining feedback from a user regarding a furniture category or a mattresses sub-category. Feedback can be obtained from a user regarding any type of category, sub-category, or item.

In this example, the feedback is a thumbs up or a thumbs down icon which the user can select to indicate the user's interest in the category, sub-category, or item. However, the embodiments are not limited to a thumbs up or thumbs down type of feedback. In other examples, the feedback can include a follow, unfollow, star, heart icon, a “more like this” request, a “less like this” request, a product or service rating, a share request to share information with someone else, as well as any other type of feedback provided by a user.

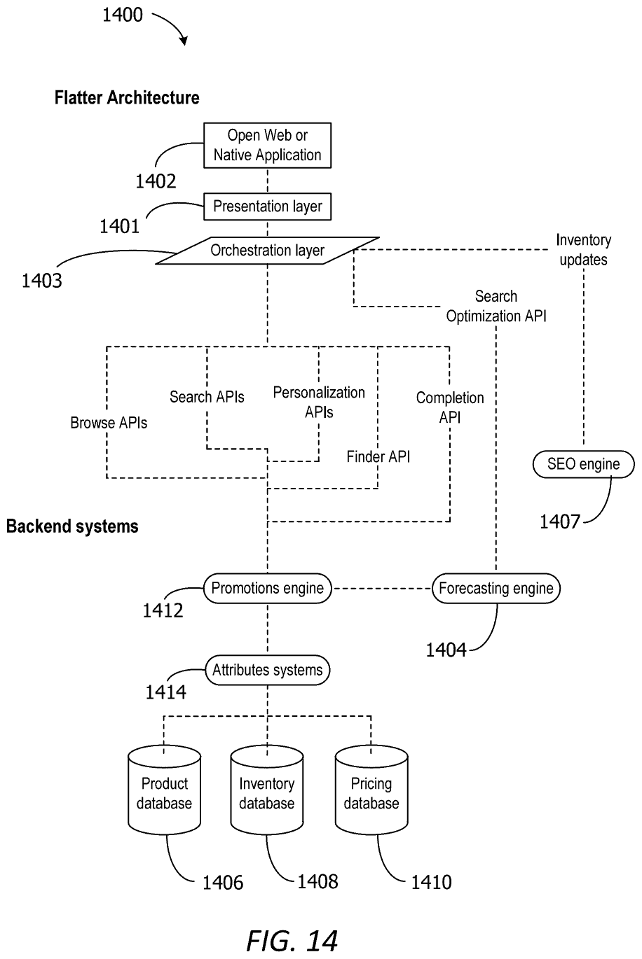

FIG. 14 is an example block diagram illustrating a backend system 1400 for dynamically generating personalized content for a user. In this example, a user accesses the multi-pane viewport via a website or application 1402 on a user device. The system 1400 can include a presentation layer 1401 and orchestration layer 1403 with a search engine optimization (SEO) engine 1407 utilizing inventory updates to further enable optimization of search results provided to users. A forecasting engine 1404 prioritizes categories and/or items for presentation to the user based on the user's preferences. The system utilizes promotional information from a promotions engine 1412, product information from a product database 1406, inventory information from an inventory database 1408, and/or pricing information from a pricing database 1410. The promotions data, pricing data, inventory data, and/or product data is used to generate item data for display within the product details pane. In some examples, attributes systems 1414 generate the items detail data using the data obtained from the product database 1406, the inventory database 1408, and/or the pricing database 1410.

### ADDITIONAL EXAMPLES

In some examples, the system provides sponsored ads embedded within the multi-pane viewport for improved efficiency and utility. Personalization is AI based, taking into consideration each user's previous shopping behaviors and trending categories for the user based on interests, geographic location of the user, etc. Instead of manual curation of a homepage, the system enables personalized homepages to be automatically generated with content curated for the user based on the user-specific data, thereby reducing human labor and time spent manually curating content for users.

The system enables users the user/customer to select the store departments and services they are interested in at that given point in time while interacting with the application or e-commerce website. This can be a periodic update users/customers make/change based on when they want certain services/departments. The user/customer is asked to select the departments, sub-categories, and/or services in which they are interested. They can change these preferences/selections at any time. This gives the user/customer full control over what data is used to show highlights of departments and services. Instead of a completely AI based solution, the user has full control on what criteria is used to show products or services to the user.

In other examples, the user has full control on which services and products are targeted or prioritized to show when they visit a store website or utilize the store application. The user is given control such that they have the ability to change and update their interests based on their life journey/stage. This preferences control optionally is presented as a modular within the user's shopping/interaction experience via a user interface associated with the website/app. It applies to product information, promotional materials, personalized suggestions, and/or general categories. There is a place in the UI to view and set user personalized preferences, giving the user full control.

In some examples, lazy loading as the user searches and browses through results, allows collective calls to the systems, reducing individual sporadic calls to the systems. The calls are only made once to the involved systems, which is exponentially more efficient.

Product and services personalization, in some examples, is performed by setting individual preferences. The shopping experience is enhanced by encouraging the user to select the departments and services they are interested in at that given point in time. Instead of a completely AI based solution, the user has partial and/or full control as to which services and products are targeted or prioritized for the user when they come to the website and/or utilize the e-commerce application.

Alternatively, or in addition to the other examples described herein, examples include any combination of the following:
display video data associated with a currently selected item within a video data pane of the multi-pane viewport;
identify a prioritized set of items for the selected category;
present the prioritized set of items for the selected category within all-items-per-category pane, wherein the prioritized set of items are presented within a grid layout within the all-items-per-category pane;
generating the multi-pane viewport using at least one template;
add a selected item to a cart associated with the user in response to receiving a user selection of a single icon for adding the selected item to the cart within the product list pane or within the product detail pane;
update categories and items presented within the multi-pane viewport based on user interaction with curated content in real time, wherein the user interaction includes user feedback;
receive user input indicating departments, sub-categories, and services of interest to the user;
update the categories and items presented within the multi-pane viewport based on the user input;
prioritizing a plurality of categories associated with a plurality of items available from a retailer using user-specific data, including historical transaction data for a user;
selecting a threshold number of highest priority categories from the prioritized plurality of categories;
presenting the highest priority categories within a product list pane of the multi-pane viewport, wherein a vertical scroll function enables a user to navigate through categories displayed within a vertical row of the product list pane, and wherein a horizontal scroll function enables the user to navigate through items associated with a selected category;
replacing a first category presented in the product list pane with a second category in response to a vertical scroll;
replacing a first item associated with the selected category in the product list pane with a second item associated with the selected category in response to a horizontal scroll;
populating a product details pane of the multi-pane viewport with item detail data associated with a selected item from a selected category, wherein the multi-pane viewport provides a flattened architecture enabling a unified view of item categories and item details within a single personalized viewport;
changing the item details data within the product details pane within the multi-pane viewport responsive to receiving a user selection of a different item in the product list pane, wherein the changed item details data includes data describing a currently selected item;
displaying video data associated with the currently selected item within a video data pane of the multi-pane viewport;
changing the video data presented within the video data pane responsive to receiving a selection of a different item in the plurality of items, thereby creating an immersive visual shopping experience;
identifying a prioritized set of items for the selected category;
presenting the prioritized set of items for the selected category within all-items-per-category pane, wherein the prioritized set of items are presented within a grid layout within the all-items-per-category pane;
adding a selected item to a cart associated with the user in response to receiving a user selection of a single icon for adding the selected item to the cart within the product list pane or within the product detail pane;
personalizing content presented via the multi-pane viewport by a machine learning (ML) model using historical transaction data and trending categories for the user based on user interests and geographic data associated with a location of the user;
dynamically modify curated content presented within the multi-pane viewport based on user interaction with the curated content in real time, wherein the user interaction includes user feedback, the feedback comprising likes, dislikes, follow, unfollow, save, heart, star, share, more of this, less of this, and item ratings;
generate a multi-pane viewport comprising a plurality of panes displaying data associated with a plurality of categories and a plurality of items associated with the plurality of categories;
populate a product list pane with a threshold number of categories from the plurality of categories;
replace a first category presented in the product list pane with a second category in response to a vertical scroll within the product list pane, the vertical scroll enabling the user to view other categories in the plurality of categories;
replace a first item associated with the selected category in the product list pane with a second item associated with the selected category in response to a horizontal scroll, wherein the horizontal scroll enables the user to view each item associated with each category of items within the product list pane;
populate a product details pane within the multi-pane viewport with item details data associated with a selected item associated with at least one category in the plurality of categories;
display video data associated with the currently selected item within a video data pane of the multi-pane viewport;
identify a prioritized set of items for the selected category;
populate all-items-per-category pane of the multi-pane viewport with a set of items associated with a selected category, wherein the set of items are presented within a grid layout within the all-items-per-category pane, wherein the multi-pane viewport provides a flattened architecture enabling a unified view of item categories and item details within a single personalized viewport;
detect a tap associated with an icon for adding an item to a cart within the product list pane or within the product detail pane;
add the item to the cart automatically, wherein the item is added to the cart with a single tap or click of the icon within the product list pane or within the product detail pane;
receive user input indicating departments, sub-categories, and services displayed within the multi-pane viewport lacking interest to the user;
update the categories and items presented within the multi-pane viewport to remove categories and items associated with the indicated departments, sub-categories, and services based on the user input;
set user personalized preferences via a user interface (UI), wherein content presented within the multi-pane viewport is modified based on the user personalized preferences;
receive search results for a user initiated search;
present the search results within the product list pane;
generate item details for a highest priority item in the search results within the product detail pane;
play video content within the video data pane;
provide a plurality of item entries associated with a highest priority category within the all-items-per-category pane; and
dynamically modify curated content presented within the multi-pane viewport based on user interaction with the curated content in real time, wherein the user interaction includes user feedback, the feedback comprising likes, dislikes, follow, unfollow, save, heart, star, share, more of this, less of this, and item ratings.

At least a portion of the functionality of the various elements in FIG. 1, FIG. 2, and FIG. 14 can be performed by other elements in FIG. 1, FIG. 2, and FIG. 14 or an entity (e.g., processor 106, web service, server, application program, computing device, etc.) not shown in FIG. 1, FIG. 2, and/or FIG. 14.

In some examples, the operations illustrated in FIG. 8, FIG. 9, and FIG. 10 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other examples, a computer readable medium having instructions recorded thereon which when executed by a computer device cause the computer device to cooperate in performing a method of creating an immersive visual shopping experience, the method comprising prioritizing a plurality of categories associated with a plurality of items available from a retailer using user-specific data, including historical transaction data for a user; selecting a threshold number of highest priority categories from the prioritized plurality of categories; presenting the highest priority categories within a product list pane of the multi-pane viewport, wherein a vertical scroll function enables a user to navigate through categories displayed within a vertical row of the product list pane, and wherein a horizontal scroll function enables the user to navigate through items associated with a selected category; replacing a first category presented in the product list pane with a second category in response to a vertical scroll; replacing a first item associated with the selected category in the product list pane with a second item associated with the selected category in response to a horizontal scroll; and populating a product details pane of the multi-pane viewport with item detail data associated with a selected item from a selected category, wherein the multi-pane viewport provides a flattened architecture enabling a unified view of item categories and item details within a single personalized viewport.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

While no personally identifiable information is tracked by aspects of the disclosure, examples have been described with reference to data monitored and/or collected from the users. In some examples, notice is provided to the users of the collection of the data (e.g., via a dialog box or preference setting) and users are given the opportunity to give or deny consent for the monitoring and/or collection. The consent can take the form of opt-in consent or opt-out consent.

### Exemplary Operating Environment

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable, and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions, or the specific components or modules illustrated in the figures and described herein. Other examples of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for dynamically personalizing content with an immersive visual shopping experience. For example, the elements illustrated in FIG. 1, FIG. 2, and FIG. 3, such as when encoded to perform the operations illustrated in FIG. 8, FIG. 9, and FIG. 10, constitute exemplary means for generating a multi-pane viewport using a template and user-specific data, the multi-pane viewport including a plurality of panes displaying data associated with a plurality of categories and a plurality of items associated with the plurality of categories; exemplary means for populating a product list pane with a threshold number of categories from the plurality of categories; exemplary means for replacing a first category presented in the product list pane with a second category in response to a vertical scroll within the product list pane, the vertical scroll enabling the user to view other categories in the plurality of categories; exemplary means for replacing a first item associated with the selected category in the product list pane with a second item associated with the selected category in response to a horizontal scroll, wherein the horizontal scroll enables the user to view each item associated with each category of items within the product list pane; exemplary means for populating a product details pane within the multi-pane viewport with item details data associated with a selected item associated with at least one category in the plurality of categories; exemplary means for displaying video data associated with the currently selected item within a video data pane of the multi-pane viewport; exemplary means for identifying a prioritized set of items for the selected category; and exemplary means for populating an all-items-per-category pane of the multi-pane viewport with a set of items associated with a selected category, wherein the set of items are presented within a grid layout within the all-items-per-category pane, wherein the multi-pane viewport provides a flattened architecture enabling a unified view of item categories and item details within a single personalized viewport.

Other non-limiting examples provide one or more computer storage devices having a first computer-executable instructions stored thereon for providing an immersive visual shopping experience via a multi-pane viewport. When executed by a computer, the computer performs operations including prioritizing a plurality of categories associated with a plurality of items using user-specific data, including historical transaction data for a user; selecting a threshold number of highest priority categories from the prioritized plurality of categories; presenting the highest priority categories within a product list pane within the multi-pane viewport, wherein a vertical scroll function enables navigation through categories displayed within the product list pane, and wherein a horizontal scroll function enables navigation through items of each category presented in the product list pane; replacing a first category presented in the product list pane with a second category in response to a vertical scroll within the product list pane, the vertical scroll enabling the user to view additional categories within the product list pane; replacing a first item associated with a selected category in the product list pane with a second item associated with the selected category in response to a horizontal scroll, wherein the horizontal scroll enables the user to view each item associated with each category within the product list pane; populating a product details pane of the multi-pane viewport with item detail data associated with a selected item from a selected category; and changing the item details data within the product details pane of the multi-pane viewport responsive to receiving a user selection of a second item in the product list pane, wherein the changed item details data includes data describing the second item, wherein the multi-pane viewport provides a flattened architecture enabling a unified view of item categories and item details within a single personalized viewport.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

The indefinite articles “a” and “an,” as used in the specification and in the claims, unless clearly indicated to the contrary, should be understood to mean “at least one.” The phrase “and/or” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to “A” only (optionally including elements other than “B”); in another embodiment, to B only (optionally including elements other than “A”); in yet another embodiment, to both “A” and “B” (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either” “one of” “only one of” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of ‘A’ and ‘B’” (or, equivalently, “at least one of ‘A’ or ‘B’,” or, equivalently “at least one of ‘A’ and/or ‘B’”) can refer, in one embodiment, to at least one, optionally including more than one, “A”, with no “B” present (and optionally including elements other than “B”); in another embodiment, to at least one, optionally including more than one, “B”, with no “A” present (and optionally including elements other than “A”); in yet another embodiment, to at least one, optionally including more than one, “A”, and at least one, optionally including more than one, “B” (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for dynamically personalizing content within a multi-pane viewport, the system comprising:
a processor; and
a computer-readable medium storing instructions that are operative upon execution by the processor to:
prioritize a plurality of categories associated with a plurality of items using user-specific data, including historical item-related data for a user;
select a threshold number of highest priority categories from the prioritized plurality of categories;
present the highest priority categories within a product list pane within the multi-pane viewport, wherein a vertical scroll function enables navigation through categories displayed within the product list pane, and wherein a horizontal scroll function enables navigation through items of each category presented in the product list pane;
replace a first category presented in the product list pane with a second category in response to a vertical scroll within the product list pane, the vertical scroll enabling the user to view additional categories within the product list pane;
replace a first item associated with a selected category in the product list pane with a second item associated with the selected category in response to a horizontal scroll, wherein the horizontal scroll enables the user to view each item associated with each category within the product list pane;
populate a product details pane of the multi-pane viewport with item detail data associated with a selected item from a selected category; and
change the item details data within the product details pane of the multi-pane viewport responsive to receiving a user selection of a second item in the product list pane, wherein the changed item details data includes data describing the second item, wherein the multi-pane viewport provides a flattened architecture enabling a unified view of item categories and item details within a single personalized viewport.

2. The system of claim 1, wherein the instructions are further operative to:
display video data associated with a currently selected item within a video data pane of the multi-pane viewport.

3. The system of claim 1, wherein the instructions are further operative to:
identify a prioritized set of items for the selected category; and
present the prioritized set of items for the selected category within an all-items-per-category pane, wherein the prioritized set of items are presented within a grid layout within the all-items-per-category pane.

4. The system of claim 1, wherein the instructions are further operative to:
generating a multi-pane viewport using at least one template.

5. The system of claim 1, wherein the instructions are further operative to:
add a selected item to a cart associated with the user in response to receiving a user selection of a single icon for adding the selected item to the cart within the product list pane or within the product detail pane.

6. The system of claim 1, wherein the instructions are further operative to:
update categories and items presented within the multi-pane viewport based on user interaction with curated content in real time, wherein the user interaction includes user feedback.

7. The system of claim 1, wherein the instructions are further operative to:
receive user input indicating departments, sub-categories, and services of interest to the user; and
update the categories and items presented within the multi-pane viewport based on the user input.

8. A method for dynamically personalizing content within a multi-pane viewport, the method comprising:
prioritizing a plurality of categories associated with a plurality of items available from a retailer using user-specific data, including historical item-related data for a user;
selecting a threshold number of highest priority categories from the prioritized plurality of categories;
presenting the highest priority categories within a product list pane of the multi-pane viewport, wherein a vertical scroll function enables a user to navigate through categories displayed within a vertical row of the product list pane, and wherein a horizontal scroll function enables the user to navigate through items associated with a selected category;
replacing a first category presented in the product list pane with a second category in response to a vertical scroll;
replacing a first item associated with the selected category in the product list pane with a second item associated with the selected category in response to a horizontal scroll; and
populating a product details pane of the multi-pane viewport with item detail data associated with a selected item from a selected category, wherein the multi-pane viewport provides a flattened architecture enabling a unified view of item categories and item details within a single personalized viewport.

9. The method of claim 8, further comprising:
changing the item details data within the product details pane within the multi-pane viewport responsive to receiving a user selection of a different item in the product list pane, wherein the changed item details data includes data describing a currently selected item.

10. The method of claim 8, further comprising:
displaying video data associated with the selected item within a video data pane of the multi-pane viewport; and
changing the video data presented within the video data pane responsive to receiving a selection of a different item in the plurality of items, thereby creating an immersive visual shopping experience.

11. The method of claim 8, further comprising:
identifying a prioritized set of items for the selected category; and
presenting the prioritized set of items for the selected category within an all-items per category pane, wherein the prioritized set of items are presented within a grid layout within an all-items-per-category pane.

12. The method of claim 8, further comprising:
adding a selected item to a cart associated with the user in response to receiving a user selection of a single icon for adding the selected item to the cart within the product list pane or within the product detail pane.

13. The method of claim 8, further comprising:
personalizing content presented via the multi-pane viewport by a machine learning (ML) model using historical item-related data and trending categories for the user based on user interests and geographic data associated with a location of the user.

14. The method of claim 8, further comprising:
dynamically modify curated content presented within the multi-pane viewport based on user interaction with the curated content in real time, wherein the user interaction includes user feedback, the feedback comprising likes, dislikes, follow, unfollow, save, heart, star, share, more of this, less of this, and item ratings.

15. One or more computer storage devices having computer-executable instructions stored thereon, which, upon execution by a computer, cause the computer to perform operations comprising:
generate a multi-pane viewport comprising a plurality of panes displaying data associated with a plurality of categories and a plurality of items associated with the plurality of categories;
populate a product list pane with a threshold number of categories from the plurality of categories;
replace a first category presented in the product list pane with a second category in response to a vertical scroll within the product list pane, the vertical scroll enabling display of other categories in the plurality of categories;
replace a first item associated with a selected category in the product list pane with a second item associated with the selected category in response to a horizontal scroll, wherein the horizontal scroll enables display of each item associated with each category of items within the product list pane;
populate a product details pane within the multi-pane viewport with item details data associated with a selected item associated with at least one category in the plurality of categories;
display video data associated with the selected item within a video data pane of the multi-pane viewport;
identify a prioritized set of items for the selected category; and
populate an all-items-per-category pane of the multi-pane viewport with a set of items associated with a selected category, wherein the set of items are presented within a grid layout within the all-items-per-category pane, wherein the multi-pane viewport provides a flattened architecture enabling a unified view of item categories and item details within a single personalized viewport.

16. The one or more computer storage devices of claim 15, wherein the operations further comprise:
detect a tap associated with an icon for adding an item to a cart within the product list pane or within the product detail pane; and
add the item to the cart automatically, wherein the item is added to the cart with a single tap or click of the icon within the product list pane or within the product detail pane.

17. The one or more computer storage devices of claim 15, wherein the operations further comprise:
receive user input indicating departments, sub-categories, and services lacking interest to the user; and
update the categories and items presented within the multi-pane viewport to remove categories and items associated with the indicated departments, sub-categories, and services based on the user input.

18. The one or more computer storage devices of claim 15, wherein the operations further comprise:
set user personalized preferences via a user interface (UI), wherein content presented within the multi-pane viewport is modified based on the user personalized preferences.

19. The one or more computer storage devices of claim 15, wherein the operations further comprise:
receive search results for a user initiated search;
present the search results within the product list pane;
generate item details for a highest priority item in the search results within the product detail pane;
play video content within the video data pane; and
provide a plurality of item entries associated with a highest priority category within the all-items-per-category pane.

20. The one or more computer storage devices of claim 15, wherein the operations further comprise:
dynamically modify curated content presented within the multi-pane viewport based on user interaction with the curated content in real time, wherein the user interaction includes user feedback, the feedback comprising likes, dislikes, follow, unfollow, save, heart, star, share, more of this, less of this, and item ratings.
